(19) United States
(12) Patent Application Publication
(10) Pub. No.: US 2008/0316995 A1
(43) Pub. Date: Dec. 25, 2008

(54) BROADCAST CHANNEL SIGNAL AND APPARATUS FOR MANAGING THE TRANSMISSION AND RECEIPT OF BROADCAST CHANNEL INFORMATION

(75) Inventors: RAJA S. BACHU, DES PLAINES, IL (US); MICHAEL E. BUCKLEY, GRAYSLAKE, IL (US); KENNETH A. STEWART, GRAYSLAKE, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/765,909

(22) Filed: Jun. 20, 2007

(51) Int. Cl. H04J 3/00

(52) U.S. Cl. 370/345

(57) ABSTRACT

The present invention provides a broadcast channel signal and apparatus for managing the transmission and receipt of broadcast channel information, where a known difference in the data prior to encoding for transmission produces a predictable difference, which can be removed or cancelled from the multiple received active frames, such that their differences can be negated prior to combining and subsequently decoding. In at least one embodiment one or more applied linear encoding techniques can allow for a predictable difference in the encoded values based upon a knowledge of the difference prior to encoding.

### FIELD OF THE INVENTION

The present invention relates generally to the management of the transmission and receipt of channel information and, more particularly, to the management of the transmission and receipt of channel information having variant and invariant information pertaining to a broadcast control channel in a wireless communication system.

### BACKGROUND OF THE INVENTION

A broadcast control channel is typically a downlink channel received from the network infrastructure that contains specific parameters needed by a mobile subscriber in order for the mobile subscriber to identify the network and gain access to it. Often times, the broadcast control channel assists the mobile in translating between a logical and a physical channel, where the broadcast control channel will sometimes include frequency and timing information, that assist in accessing the network infrastructure's other channels.

Because of the importance of the broadcast control channel information in establishing a wireless communication link between the mobile subscriber and the network infrastructure, it is beneficial to organize and arrange the control channel information so as to enhance the reliability of the communication of the broadcast channel information. In at least some instances, the data will be encoded so as to include error detection and error correction information, as well as transmit information redundancies.

In at least some instances, the broadcast control channel information will be organized and arranged to be communicated during transmission intervals, where some of the broadcast control channel information may be communicated multiple times during which at least some of the information will remain the same or static. Each separate transmission within a transmission interval is sometimes embedded within a specific subinterval of the transmission interval referred to as a frame, where all or some of the frames associated with a particular broadcast communication channel, herein referred to as an active frame, may include broadcast control channel information. In some instances, some of the broadcast control channel information may vary between frames.

For example, information such as channel bandwidth, base station, and reference power levels, which may be periodically transmitted via a broadcast control channel may be defined as remaining static and/or invariant for the duration of a transmission interval. Other information such as system frame number, which corresponds to a system time reference may be allowed to vary between frames, even within a transmission interval.

In at least some proposals, the static information may be encoded using various transmission configurations, which define the conditions under which and the nature of a combination of encoding, modulating, interleaving and scrambling is performed, which in at least some instances can serve to further assist in the reliable receipt of the same. Multiple static retransmissions of the encoded data using the same or related transmission configurations can be used to allow for the combining of the received information by the mobile station across multiple transmissions or active frames within a particular transmission interval. However, the incorporation and/or encoding of some information that varies between frames can make the combining of multiple transmissions across multiple active frames of a transmission interval more difficult, as it is not always clear to the receiver how the varying data might affect the format after encoding between active frames during which the broadcast channel information is being transmitted. As a result, information that varies between frames is sometimes excluded from some encodings, which are used to enhance the reliability of the information being communicated.

The applicants have recognized that it is possible to apply a transformation, where the encoded differences can be negated, so as to allow the combining of the encoded received broadcast channel information prior to decoding, where the encoding will produce a predictable difference between data associated with the plurality of successively transmitted active frames having a known difference prior to encoding based upon a known relationship between the frames in which the broadcast channel information is encoded within a particular transmission interval, and where the predictable differences can be negated. Furthermore, the applicants have recognized, that the encoding produces a predictable difference, when the data is encoded using one or more linear encoding techniques, and the difference prior to encoding is known.

### SUMMARY OF THE INVENTION

The present invention provides a broadcast channel signal. The broadcast channel signal includes one or more transmission intervals, each transmission interval including a plurality of transmissions. One or more of the plurality of transmissions are active frames that include a jointly encoded set of data including a variant portion, which changes between multiple active frame transmissions within a particular transmission interval, and an invariant portion, which does not change between multiple frame transmissions within the particular transmission interval. Known differences between the data associated with a plurality of sequentially transmitted active frames within a particular transmission interval prior to encoding will produce a predictable difference between data associated with the plurality of successively transmitted active frames within a particular transmission interval after encoding.

In at least one embodiment, the jointly encoded set of data is encoded using one or more linear encoding techniques.

The present invention further provides a wireless communication device. The wireless communication device includes a receiver for receiving a wireless communication signal in the form of one or more transmission intervals, where each transmission interval includes a plurality of transmissions. One or more of the plurality of transmissions are active frames. The wireless communication device further includes a decoder for converting the received signal into the data intended to be transmitted prior to an encoding for transmission. The decoder includes a controller, where the controller is adapted to attempt to decode each active frame as it is received. The controller is further adapted to combine multiple active frames, when one or more of the received active frames can not be separately decoded, where prior to combining the multiple active frames, a transformation is applied to at least one of the received active frames prior to combining. The transformation is based upon a predictable difference after encoding between the data associated with a plurality of successively transmitted active frames within a particular transmission interval determined from assumed differences between the data associated with the plurality of successively transmitted active frames within the particular transmission interval prior to encoding.

These and other objects, features, and advantages of this invention are evident from the following description of one or more preferred embodiments of this invention, with reference to the accompanying drawings.

### BRIEF DESCRIPTION OF THE DRAWINGS

FIG. 1 is an exemplary topographical view of a geographical region representing at least a portion of the coverage area for a wireless communication system;

FIG. 2 is a block diagram of a broadcast channel signal;

FIG. 3 is a block diagram of broadcast channel information, which forms the basis of the information encoded and used to form an active frame for transmission;

FIG. 4 is a block diagram of a wireless communication device, such as a mobile subscriber, and the portion of the cellular network infrastructure with which the communication device more directly communicates in connection with the receipt of a broadcast channel signal;

FIG. 5 is a more detailed block diagram of a mobile subscriber for use in receiving a wireless communication signal, and decoding the same, in accordance with at least one embodiment of the present invention; and

FIG. 6 is a flow diagram of a method of receiving and attempting to decode one or more successively transmitted frames in a wireless communication device for a broadcast of interest in a cellular communication network.

### DETAILED DESCRIPTION OF THE PREFERRED EMBODIMENT(S)

While the present invention is susceptible of embodiment in various forms, there is shown in the drawings and will hereinafter be described presently preferred embodiments with the understanding that the present disclosure is to be considered an exemplification of the invention and is not intended to limit the invention to the specific embodiments illustrated.

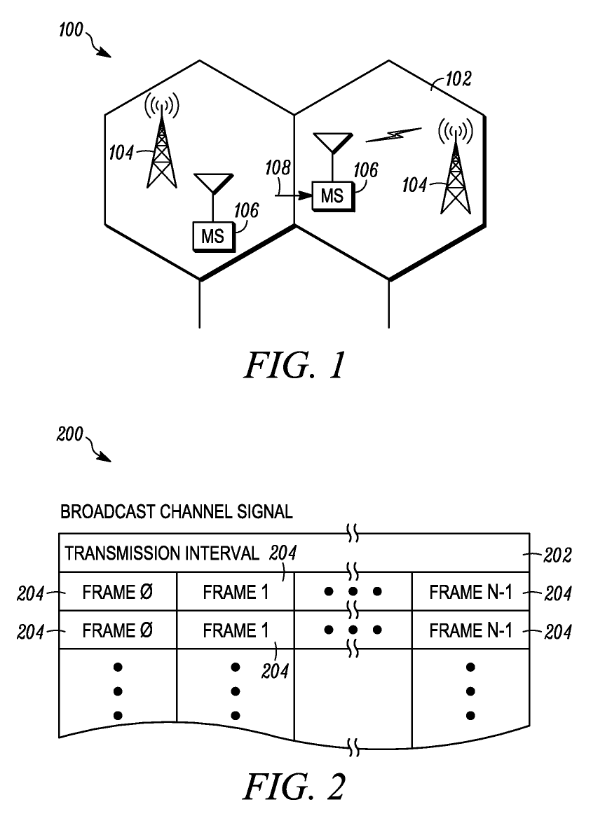

FIG. 1 illustrates an exemplary topographical view of at least a portion of a wireless communication system. The topographical view 100 includes a plurality of cells 102 pictorially represented as adjacent hexagons. The hexagons are only rough approximations of the footprint or area of coverage associated with each of a plurality of cellular regions, where in reality the area of transmission is not so uniformly defined. Each cell is typically served by one or more base transceiver stations (BTS) 104, referred to as a serving station, which communicates with mobile subscriber (MS) 106, such as a mobile wireless communication device, located and/or traveling 108 within the corresponding cell 102.

As a mobile subscriber 106 powers on or enters a new cell, a mobile subscriber will need to acquire the signaling information associated with the new cell. In many cases, this will involve monitoring one or more broadcast control channels, so as to allow the mobile station to obtain synchronization, timing and/or other related information consistent with establishing communication capabilities with the new cell. Because control channel reception is often a precursor for establishing other forms of communication with a particular cellular area, a more robust and/or effective manner in establishing a communication connection and receiving the information being conveyed by the broadcast control channel is desirable. The broadcast channel signal 200 is arranged in one or more transmission intervals 202, which each includes a plurality of transmissions or frames 204, where one or more of the transmissions are active frames in which broadcast channel information is transmitted. In the embodiment illustrated in FIG. 2, a transmission interval 202 coincides with a row of N frames, where N is an integer value.

In some cases, the broadcast channel signal will be encoded as part of each frame in a transmission interval. In other instances, it is possible that broadcast channel information will be transmitted on fewer than all of the corresponding frames. As noted above, frames in which broadcast channel information is transmitted as part of the transmission frame are identified in the present application as active frames. By transmitting on fewer than all of the frames associated with a particular transmission interval, the frames which do not support transmission of the broadcast channel signal, can be made available to other forms and/or types of data transmission.

In some instances it may be desirable to combine multiple active frames to more quickly and/or better receive the information being conveyed via the broadcast channel signal. Hence, the repeated transmission of at least some broadcast channel information across multiple active frames within a particular transmission interval. However, not all information can be readily repeated, where for example, in at least one discussed proposal, the broadcast information includes a system frame number that varies with each frame transmission.

Generally, broadcast channel information often includes both an invariant portion and a variant portion. However, even some subportions of the variant portion can be invariant. Furthermore, by more specifically controlling the relationship between the value of the variant portion, such as the system frame number, with respect to the beginning boundary value of the transmission interval and more specifically controlling the number of transmissions or frames in a transmission interval, the number of variant information bits in the variant subportion of the variant portion can be better managed. For example numbering the system frames, so that the frame number of the first frame after the beginning boundary of the transmission interval has a modulus n value that is equal to zero, where n is the number of transmissions (i.e. frames) in the transmission interval, can minimize the number of bits across which the system frame number might have a different bit value in any two transmissions in a particular transmission interval. In such an instance, the system frame number can predictably change, and in at least one embodiment of the present invention, increments by one in each adjacent subsequent frame. However, one skilled in the art will readily recognize the value of the present invention regardless as to whether the value of the system frame number is defined to increment for adjacent subsequently transmitted frames, as noted above, where alternatively a properly defined predetermined predictable sequence can also benefit from the teachings of the present invention, if the system frame values from which the frames in a particular transmission interval are assigned and are selected from a list of values where a predefined predictable set of bits are allowed to change within the particular transmission interval.

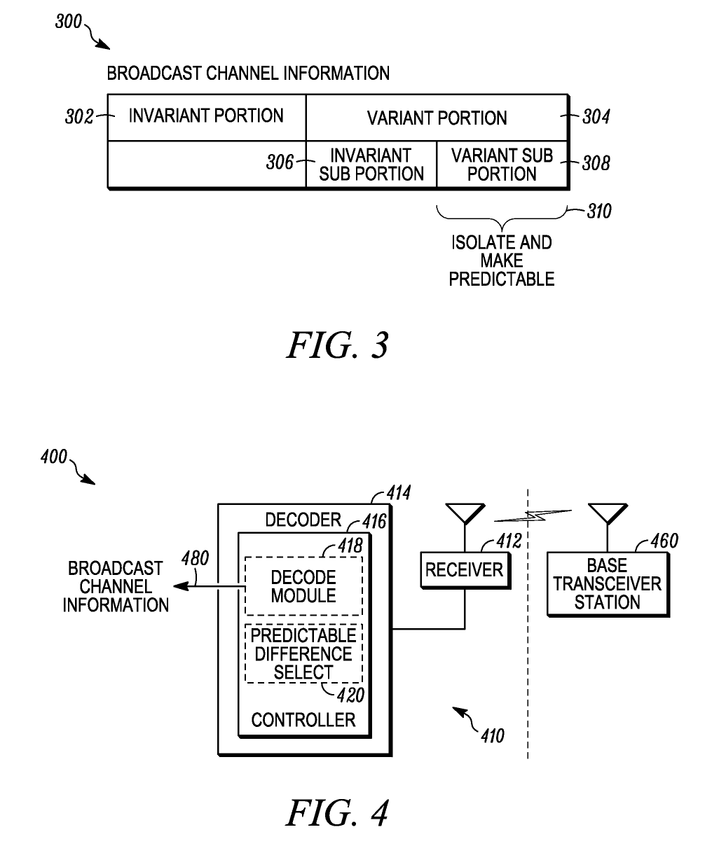

FIG. 3 illustrates broadcast channel information 300, in accordance with at least one aspect of the present invention, where generally, the broadcast channel information 300 will include an invariant portion 302 and a variant portion 304, where the variant portion 304 to the extent that all of the bits do not change or do not need to change within a transmission interval 202 is further subdivided into an invariant subportion 306 and a variant subportion 308. In the illustrated embodiment the variant subportion where the least significant bits, which are likely to change have a corresponding value associated with the frame within the transmission interval beginning with zero and counting incrementally each subsequent adjacent frame.

In the illustrated embodiment, the variant subportion represents an isolation of the varient subportion where the predictable difference between adjacent successively transmitted active frames is known and allows for a predictable difference in the corresponding encoded values without actually knowing the corresponding values prior to encoding. In this way, the variant subportion which has been isolated can be negated, so as to allow the subsequent combining of the multiple received encoded transmissions.

With regards to decoding a received active frame, the wireless communication device can attempt to decode the encoded data. Nevertheless, in some circumstances, it may not be possible to decode the broadcast channel information 300, based upon the receipt of a single active frame. In these instances, upon receipt of a subsequent active frame, the earlier received active frame and the latter received active frame can be used to attempt to combine and decode the multiple received transmissions. In this instance the wireless communication device can make one or more assumptions regarding the position of the frame relative to the beginning boundary of the transmission interval, and then determine an appropriate predictable difference value to apply to one of the signals received in the pair of active frames, where the purpose is an attempt to negate any differences between the two received signal values. In some instances, the wireless communication device can cycle through each possible assumption, which may result in a different predictable difference being applied, based upon an understanding of the relationship of the two active frames being combined prior to transmission. An attempt to decode is then made.

The process can be further repeated as necessary to include still further additional active frames, in the attempt to combine and decode. Alternatively, in the event that any of the earlier received active frames are determined to be preferably excluded from further attempts to combine, the same can be eliminated from the current set of received signals from active frames that are being considered. At least one reason to exclude an earlier received active frame may be based upon a belief or an understanding that the invariant broadcast channel information may only be invariant across the transmission of the active frames of a particular transmission interval, such that one might exclude an earlier received active frame on the assumption that it was potentially part of a different earlier transmission interval across which an invariance of the broadcast channel information between different active frames can not be confirmed. It is also possible however, to readily extend the method of combining and decoding based on assumptions concerning the state of the invariant and variant broadcast information to include the case where the receiver makes a further assumption that the portion of the broadcast information that is invariant within a transmission interval also does not change from one transmission interval to the next.

FIG. 4 illustrates a block diagram 400 of a wireless communication device 410, such as a mobile subscriber, and the portion of the cellular network infrastructure 460 with which the wireless communication device 410 more directly communicates in connection with the receipt of a broadcast channel signal 200. The wireless communication device 410 includes a receiver 412 for receiving a wireless communication signal. The wireless communication device 410 further includes a decoder 414 for converting the received wireless communication signal into broadcast channel information 480, which was intended to be transmitted in connection with the encoding for transmission.

The decoder 414 further includes a controller 416 including a decode module 418, which is adapted to attempt to decode each active frame of the received wireless communication signal, as it is received using a decoding sequence, respectively corresponding to a transmission specific configuration governing the original encoding. The controller additionally includes a predictable difference select 420, which is adapted to identify an assumed predictable difference in the encoded value between a pair of received signals associated with a pair of active frames. For the present purpose, a decoding sequence means a sequence of receiver processing operations designed in complementary fashion to the assumed transmitter configuration used to encode the broadcast channel information, i.e. a sequence of operations (in the order appropriate to the transmitter configuration) of de-encoding, de-modulating, de-interleaving and de-scrambling. Similarly, the decoder 414 of the wireless communication device 410 can be used to attempt to decode a combination of multiple active frames in the event that the decoder 414 is unable to decode a single received active frame.

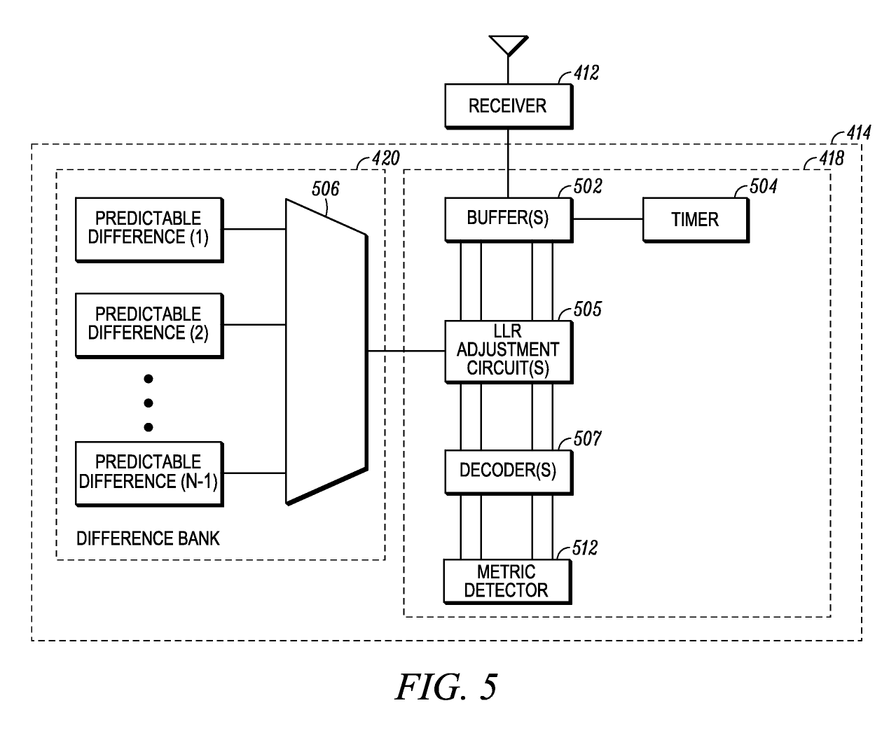

FIG. 5 illustrates a more detailed block diagram 500 of a mobile subscriber for use in receiving a wireless communication signal, and decoding the same, in accordance with at least one embodiment of the present invention. Similar to the wireless communication device 400 illustrated in FIG. 4, the mobile subscriber includes a receiver 412 for receiving a wireless communication signal, which is coupled to decoder 414. The decoder includes a decode module 418 and a predictable difference select module 420. The decode module 418 includes one or more buffers 502 for storing active frames that have been previously received. A timer 504 provides a relative temporal relationship of the active frames received, such that a more accurate association can be made relative to the decoding of other received active frames, in view of an assumption relative to a first received active frame. This can account for instances in which intermediate active frames between two received active frames may not have been received and/or transmitted for one or more reasons.

The buffers 502 are coupled to one or more log likelihood ratio adjustment circuits 505, which are adapted to selectively separately apply one of one or more predictable differences to each of the wireless communication signals that have been received and are stored in the one or more buffers 502, and forward the corrected values to the decoders 507. The separate selective application of one or more predictable differences can be accomplished via a demultiplexor 506 coupled to definitions for one or more predictable differences 508, based upon a set of known differences prior in the broadcast channel information prior to encoding.

Upon attempting to decode the active frames that have been previously received, the attempted decodings are then applied to a metric detector 512, which identifies the threshold at which a match associated with a successful decoding is confirmed. This may include e.g. checking a cyclic redundancy check code.

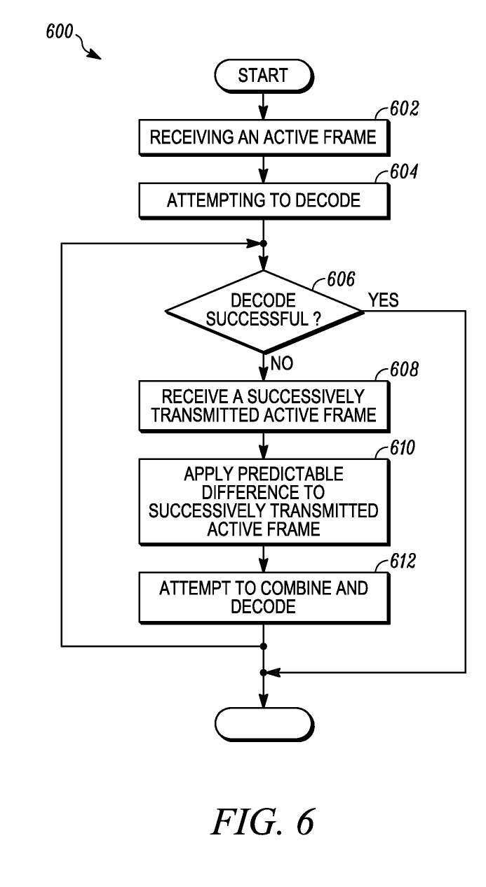

FIG. 6 illustrates a flow diagram 600 of a method of receiving and attempting to decode one or more successively transmitted frames in a wireless communication device for a broadcast of interest in a cellular communication network. The method includes receiving a first active frame 602, and attempting to decode 604 the broadcast channel information from the received frame. A determination 606 is then made as to whether the particular active frame can be decoded. If yes, no further processing is necessary in conjunction with decoding the particular frame. However the decoded frame could be used as part of attempts to decode other related active frames that have been received. If the decoding of the frame was unsuccessful, a successively transmitted active frame is received 608. An attempt is then made to decode and combine the multiple active frames 612, after an assumed predictable difference is applied 610 to the successively transmitted active frame, which is consistent with the relative transmission sequence of the successively transmitted active frame relative to the first active frame received.

In at least some embodiments, the application of one or more linear encodings techniques can allow for a predictable difference, based upon a known difference prior to encoding. Examples of several techniques that can be linearly applied include convolutional encoding, a cyclic redundancy check, data interleaving, turbo encoding, the puncturing of predefined portions of the data, as well as the repetition of predefined portions of the data.

While the present application focuses on an encoding based upon techniques that can be linearly applied, and a predictable difference in the encoded values based upon a known difference in the values prior to encoding, based upon the relative position of the active frame with respect to a transmission interval boundary, the application of one or more additional encodings including some which may not be linear in nature are possible without departing from the teachings of the present invention. For example, it may be desirable to apply cell specific configuration, which can includes a cell specific channel interleaving and/or a cell specific channel scrambling (non-linear), in order to assist in distinguishing between different transmissions from different cellular base transceiver stations, so long as the appropriate decoding is accounted for at the receiver.

Furthermore while the present application generally refers to a mobile station, or a mobile wireless communication device, one skilled in the art will recognize the many different forms that are encompassed by such a generalized description including but not limited to cellular radio telephone, pagers, personal digital assistants, as well as other devices which support the wireless communication through their interaction with a cellular network infrastructure.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A broadcast channel signal comprising:
one or more transmission intervals, each transmission interval including a plurality of transmissions, where one or more of the plurality of transmissions are active frames that include a jointly encoded set of data including a variant portion, which changes between multiple active frame transmissions within a particular transmission interval, and an invariant portion, which does not change between multiple frame transmissions within the particular transmission interval;
wherein known differences between the data associated with a plurality of sequentially transmitted active frames within a particular transmission interval prior to encoding will produce a predictable difference between data associated with the plurality of successively transmitted active frames within a particular transmission interval after encoding.

2. A broadcast channel signal in accordance with claim 1, wherein the jointly encoded set of data is encoded using one or more linear encoding techniques.

3. A broadcast channel signal in accordance with claim 2, wherein the one or more linear encoding techniques includes a convolutional encoding.

4. A broadcast channel signal in accordance with claim 2, wherein the one or more linear encoding techniques includes a cyclic redundancy check.

5. A broadcast channel signal in accordance with claim 2, wherein the one or more linear encoding techniques includes data interleaving.

6. A broadcast channel signal in accordance with claim 2, wherein the one or more linear encoding techniques includes turbo encoding.

7. A broadcast channel signal in accordance with claim 2, wherein the one or more linear encoding techniques includes puncturing predefined portions of the data.

8. A broadcast channel signal in accordance with claim 2, wherein the one or more linear encoding techniques includes repeating predefined portions of the data.

9. A broadcast channel signal in accordance with claim 1, wherein the variant portion includes a system frame number which changes between the transmission of each transmission.

10. A broadcast channel signal in accordance with claim 9, wherein the system frame number associated with the first transmission in a particular transmission interval has a mod n value of zero, where n is the number of frames in the transmission interval, and wherein the number of transmissions in the transmission interval has a value of 2 raised to an integer power.

11. A broadcast channel signal in accordance with claim 10, wherein the variant portion of the transmission includes an invariant subportion and a variant subportion, and wherein the variant subportion includes a number of bits equal to the integer power that the value of 2 was raised to for identifying the number of frames in the transmission interval.

12. A broadcast channel signal in accordance with claim 1, wherein the encoding of each active frame in the transmission interval is based upon the position of the active frame within the sequence of frames forming the transmission interval.

13. A broadcast channel signal in accordance with claim 1, wherein the encoding of each active frame in the transmission interval is based upon the source of the transmission.

14. A broadcast channel signal in accordance with claim 13, wherein the source of the transmission is a cellular communication system base transceiver station.

15. A wireless communication device comprising:
a receiver for receiving a wireless communication signal in the form of one or more transmission intervals, where each transmission interval includes a plurality of transmissions, where one or more of the plurality of transmissions are active frames; and
a decoder for converting the received signal into the data intended to be transmitted prior to an encoding for transmission, said decoder including a controller, wherein the controller is adapted to attempt to decode each active frame as it is received, and wherein the controller is adapted to combine multiple active frames, when one or more of the received active frames can not be separately decoded, where prior to combining the multiple active frames, a transformation is applied to at least one of the received active frames prior to combining, where the transformation is based upon a predictable difference after encoding between the data associated with a plurality of successively transmitted active frames within a particular transmission interval determined from assumed differences between the data associated with the plurality of successively transmitted active frames within the particular transmission interval prior to encoding.

16. A wireless communication device in accordance with claim 15, wherein the wireless communication signal is a broadcast channel, where each active frame includes a jointly encoded set of data including a variant portion, which changes between multiple active frame transmissions within a particular transmission interval, and an invariant portion, which does not change between multiple active frame transmissions within the particular transmission interval.

17. A wireless communication device in accordance with claim 15, wherein the decoder includes a plurality of received signal buffers, wherein the number of received signal buffers is equal to the number of active frames in each transmission interval.

18. A wireless communication device in accordance with claim 17, wherein the earliest received active frame in the received signal buffers is assumed to be the first of the plurality of active frames transmitted in the particular transmission interval.

19. A wireless communication device in accordance with claim 15, wherein the multiple active frames combined by the controller are successively transmitted active frames, which are adjacently transmitted.

20. A wireless communication device in accordance with claim 15, wherein the decoder includes a timer for detecting the time interval between receipt of each active frame.
